(19) United States
(12) Patent Application Publication
(10) Pub. No.: US 2020/0366117 A1
(43) Pub. Date: Nov. 19, 2020

(54) CONTROL DEVICE FOR LITHIUM ION SECONDARY BATTERY AND CONTROL METHOD THEREOF

(71) Applicant: Panasonic Intellectual Property Management Co., Ltd., Osaka (JP)

(72) Inventor: Shuichiro YAMAGUCHI, Fukuoka (JP)

(21) Appl. No.: 16/984,203

(22) Filed: Aug. 4, 2020

Related U.S. Application Data
(63) Continuation of application No. PCT/JP2019/004429, filed on Feb. 7, 2019.

(30) Foreign Application Priority Data
Feb. 7, 2018 (JP) 2018-020310

(51) Int. Cl. H02J 7/00

(52) U.S. Cl. CPC H02J 7/007182; H02J 7/0013; H02J 7/00714; H02J 7/007194

(57) ABSTRACT

A control device for controlling a lithium ion secondary battery includes a controller that detects a charging current when performing constant voltage charging to the lithium ion secondary battery, wherein the controller stops charging of the lithium ion secondary battery and records control information based on the increase of the charging current into a storage unit included in the lithium ion secondary battery, when the charging current increases by a predetermined amount within a predetermined time period.

### CROSS-REFERENCE TO RELATED APPLICATIONS

This is a continuation application of International Application No. PCT/JP2019/004429, with an international filing date of Feb. 7, 2019, which claims priority of Japanese Patent Application No.: 2018-020310 filed on Feb. 7, 2018, the content of which is incorporated herein by reference.

### BACKGROUND

### 1. Technical Field

The present disclosure relates to a control device for controlling a lithium ion secondary battery and a control method thereof.

### 2. Related Art

The lithium ion secondary battery uses an electrolyte in which lithium is in an ion state. The lithium has a characteristic that the reaction is fast and smoke and ignition are caused by reaction heat. Therefore, by performing temperature control or the like in the conventional lithium ion secondary battery, a countermeasure such as stopping operation immediately before reaching smoke and ignition has been taken.

In JP-A-10-92476, a temperature-measuring device is installed in a lithium ion secondary battery, and a change in temperature is managed using a differential value or the like, whereby a small short-circuit phenomenon occurring inside the battery is grasped, and the operation stop of the battery is determined. It is pointed out that this small short-circuit phenomenon is likely to occur especially in a state in which the lithium ion secondary battery is overcharged.

### SUMMARY

However, in the conventional technique, the occurrence of these events is suppressed by capturing a phenomenon immediately before the lithium ion secondary battery reaches smoking and ignition. As a result, even when abnormality is detected, there is a possibility that a sufficient time cannot be secured and cannot be dealt with.

To solve the problem of erroneous detection in which abnormality is erroneously detected to a normal lithium ion secondary battery when the occurrence of abnormality is to be detected in advance more than before.

The present disclosure provides a control device of the lithium ion secondary battery that can more accurately detect abnormal occurrence of a lithium ion secondary battery by newly finding a sign of an abnormal state such as smoking, ignition, etc. of a lithium secondary battery.

A control device for controlling a lithium ion secondary battery includes a controller that detects a charging current when performing constant voltage charging to the lithium ion secondary battery, wherein the controller stops charging of the lithium ion secondary battery and records control information based on the increase of the charging current into a storage unit included in the lithium ion secondary battery, when the charging current increases by a predetermined amount within a predetermined time period.

A control device for controlling a lithium ion secondary battery includes a controller that calculates a temperature of the battery cell constituting the lithium ion secondary battery, wherein the controller records control information based on the temperature calculation into a storage unit included in the lithium ion secondary battery, when the temperature rises by a predetermined amount or more within a predetermined period of time.

A control device for controlling a lithium ion secondary battery includes a controller that detects a voltage of the battery cell constituting the lithium ion secondary battery, after the lithium ion secondary battery is charged to a predetermined voltage or more, wherein the controller records control information based on the voltage detection to a storage unit included in the lithium ion secondary battery, when the voltage drop of the voltage is different from the voltage drop of the battery cell of the reference model by a predetermined amount or more.

The control device of the lithium ion secondary battery according to the present disclosure can detect abnormality of the lithium ion secondary battery more accurately as compared with a conventional one by finding a new sign of abnormality.

### BRIEF DESCRIPTION OF DRAWINGS

FIG. 1 is an external view of an electronic apparatus equipped with a lithium ion secondary battery;

FIG. 2 is a functional configuration diagram of the electronic apparatus equipped with the lithium ion secondary battery;

FIG. 3 is a configuration diagram of the lithium ion secondary battery;

FIG. 4 is a graph illustrating charging method when charging lithium ion secondary battery;

FIGS. 5A and 5B are graphs each showing a state of a charging current during CV charging;

FIG. 6 is a flowchart for detecting an increase in current during CV charging;

FIG. 7 is a graph showing an example of temperature variation of a battery cell block;

FIG. 8 is a flowchart showing contents of temperature rise detection processing;

FIGS. 9A, 9B and 9C are graphs each showing a change in battery voltage immediately after full charge; and

FIG. 10 is a flowchart of voltage detection processing of a battery cell.

### DETAILED DESCRIPTION

Hereinafter, an embodiment will be described in detail with reference to the drawings. However, a detailed description may be omitted more than necessary. For example, a detailed description of already well-known matters and a redundant description of substantially the same constitution may be omitted. This is to avoid unnecessarily redundant description, and to facilitate understanding of those skilled in the art.

In addition, the inventor provides the accompanying drawings and the following description in order for those skilled in the art to fully understand the present disclosure. The drawings and the description are not intended to limit the subject matter described in the claims.

### First Embodiment

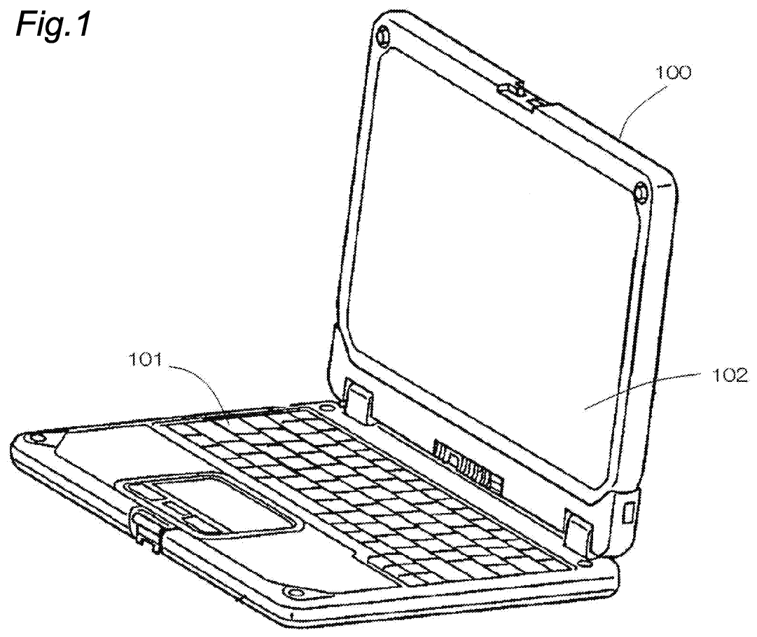

FIG. 1 is an external view of an electronic apparatus equipped with a lithium ion secondary battery. A personal computer 100 is equipped with a lithium ion secondary battery (not shown) for operating. The lithium ion secondary battery is stored, for example, on the bottom surface of the rear side of a keyboard 101 or on the rear side of the bottom surface of the joint portion between the keyboard 101 and the display 102.

A personal computer is shown as an example of an electronic apparatus equipped with a lithium ion secondary battery. However, the present disclosure is not limited to this. The electronic apparatus may be any electronic apparatus that operates with a lithium ion secondary battery mounted thereon.

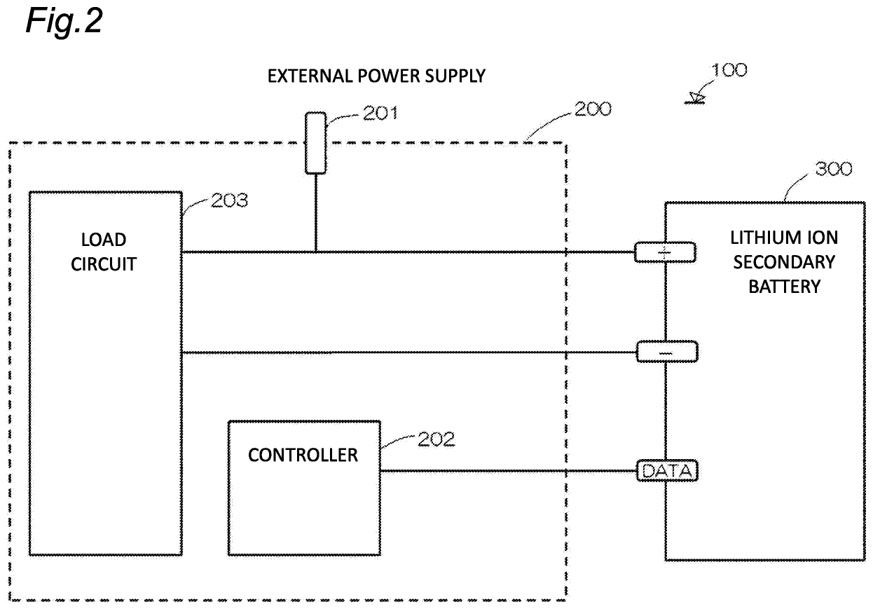

FIG. 2 is a functional configuration diagram of an electronic apparatus equipped with a lithium ion secondary battery described in the present embodiment. The personal computer 100 includes a main body 200 and a lithium ion secondary battery 300.

The main body 200 includes a power supply terminal 201, a controller 202, and a load circuit 203.

The power supply terminal 201 is a terminal to which a power supply line or the like is connected when power is supplied from the outside. The lithium ion secondary battery 300 performs charging using the power supplied from this.

The controller 202 controls the load circuit 203 of the personal computer 100, and other hardware. In particular, in the present embodiment, the controller 202 controls the lithium ion secondary battery 300.

The controller 202 can be realized (configured) by an MPU (micro-processing unit), a dedicated IC (integrated circuit), or the like. The controller 202 can be realized by a DSP (digital signal processor), an FPGA (field programmable gate array), or the like.

The load circuit 203 is an electric circuit operated by electric power inputted from the power supply terminal 201 or power supplied from a lithium ion secondary battery 300. In the case of the personal computer 100, various devices constituting a general computer such as a CPU, a memory, and a display correspond thereto.

The lithium ion secondary battery 300 has one or more cells of a lithium ion secondary battery. By charging and discharging these cells, electric power from the main body 200 can be accumulated, or power can be supplied to the main body 200. The lithium ion secondary battery 300 is electrically connected to the main body 200 by a positive connection terminal and a minus connection terminal (power supply connection terminal), and a data communication terminal.

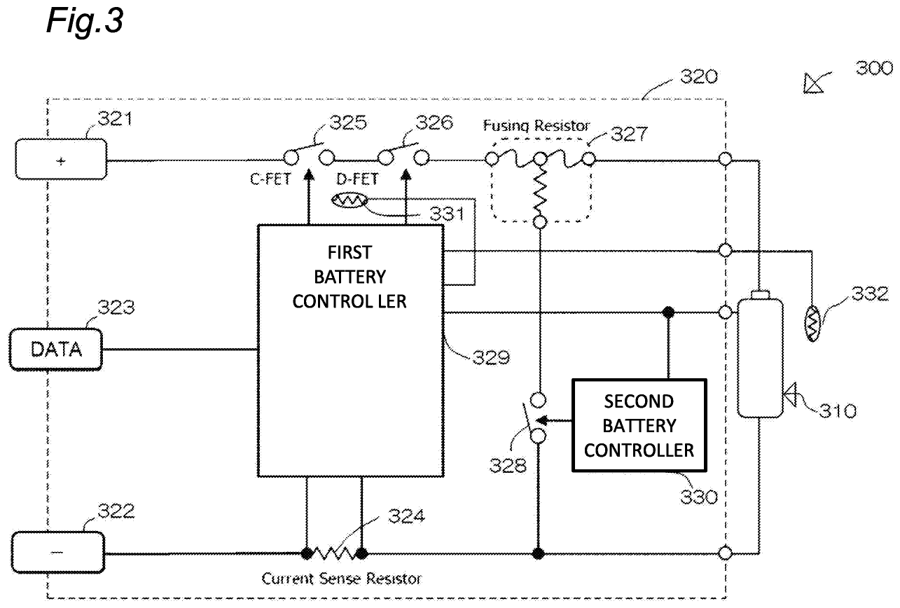

FIG. 3 is a configuration diagram of the lithium ion secondary battery described in the present embodiment. The lithium ion secondary battery 300 includes a battery cellblock 310 and a control module 320.

The battery cell block 310 includes a battery cell capable of charging lithium ions as an electrolyte. The battery cell block 310 has one or a plurality of battery cells according to the performance required for the lithium ion secondary battery.

The control module 320 controls charging and discharging of the battery cell block 310. The control module 320 includes a positive terminal 321, a minus terminal 322, a DATA terminal 323, a current detection resistor 324, a charge switch 325, a discharge switch 326, a fuse 327, a switch 328, a first battery controller 329, a second battery controller 330, a first temperature sensor 331, and a second temperature sensor 332.

The positive terminal 321 and the minus terminal 322 are terminals electrically connected when the lithium ion secondary battery 300 is charged from the main body 200 or when the lithium ion secondary battery 300 is discharged from the lithium ion secondary battery 300 to the main body 200. The lithium ion secondary battery 300 exchanges DC power with the main body 200.

The DATA terminal 323 is a terminal used when the main body 200 and the lithium ion secondary battery 300 communicate with each other. More specifically, the controller 202 of the main body 200 and the first battery controller 329 of the lithium ion secondary battery 300 transmit and receive data, commands, and the like via the terminal.

The current detection resistor 324 is an electric resistance used for detecting a current of electric power discharged from the lithium ion secondary battery 300 or a current of electric power when charging the lithium ion secondary battery 300. A voltage difference between both ends is measured by the first battery controller 329 to calculate a current value.

The charge switch 325 and the discharge switch 326 are switches used to control the battery cell block 310, respectively. These switches are controlled by the first battery controller 329.

When power is charged to the battery cell block 310, the first battery controller 329 controls the charge switch 325 and the discharge switch 326 in order to suppress the battery cell constituting the battery cell block 310 from being an overvoltage state or an over-discharge state. These switches are realized by, for example, a MOSFET.

The fuse 327 is provided for protecting the battery cell block 310 from overcurrent or over-charging (overvoltage). When detecting an overcurrent or an overvoltage to the battery cell block 310, the second battery controller 330 turns on the switch 328 to supply a current to the resistor of the fuse 327. The resistance of the fuse 327 fuses the fuse 327 due to heat generated by the current. Thus, the battery cell block 310 is electrically disconnected and protected from an overcurrent or an overvoltage.

The first battery controller 329 controls the entire lithium ion secondary battery 300. The first battery controller 329 communicates with the controller 202 of the main body 200 via the DATA terminal 323. The first battery controller 329 calculates a current value based on a voltage difference acquired from both ends of the current detection resistor 324.

The first battery controller 329 controls the charge switch 325 and the discharge switch 326. The first battery controller 329 acquires temperature information from the first temperature sensor 331 and the second temperature sensor 332. The first battery controller 329 measures not only the current and temperature but also the voltage of the battery cell block 310. When the battery cell block 310 is composed of a plurality of battery cells by serial connection, not only the whole voltage but also the voltages of all the battery cells are individually measured.

The first battery controller 329 is connected to a non-volatile storage medium (not shown). These can be realized by, for example, an EEPROM (electrically erasable programmable read-only memory), a NAND-type flash memory, or the like. The first battery controller 329 records the calculated current value, the acquired temperature information, and the voltage value of the battery cell block 310 on the storage medium as needed. To provide a method of manufacturing a semiconductor device. The first battery controller 329 records the information instructed by the controller 202 on the storage medium.

The second battery controller 330 is provided for protecting the battery cell block 310. When an abnormality or the like of the battery cell block 310 is detected despite the fact that the first battery controller 329 controls the charge switch 325 and the discharge switch 326, the second battery controller 330 turns on the switch 328 to fuse the fuse 327.

The first battery controller 329 and the second battery controller 330 can be realized (configured) by an MPU (micro-processing unit), a dedicated IC (integrated circuit), or the like. The first battery controller 329 and the second battery controller 330 can be realized by a DSP (digital signal processor), an FPGA (field programmable gate array), or the like.

The nonvolatile storage medium connected to the first battery controller 329 may be provided independently of the first battery controller 329, or may be provided inside the first battery controller 329.

The first temperature sensor 331 measures the temperature of the charge switch 325 and the discharge switch 326. The second temperature sensor 332 measures the temperature of the battery cell block 310. When the battery cell block 310 is composed of a plurality of battery cells, the second temperature sensor 332 may be configured to measure the temperature of each battery cell.

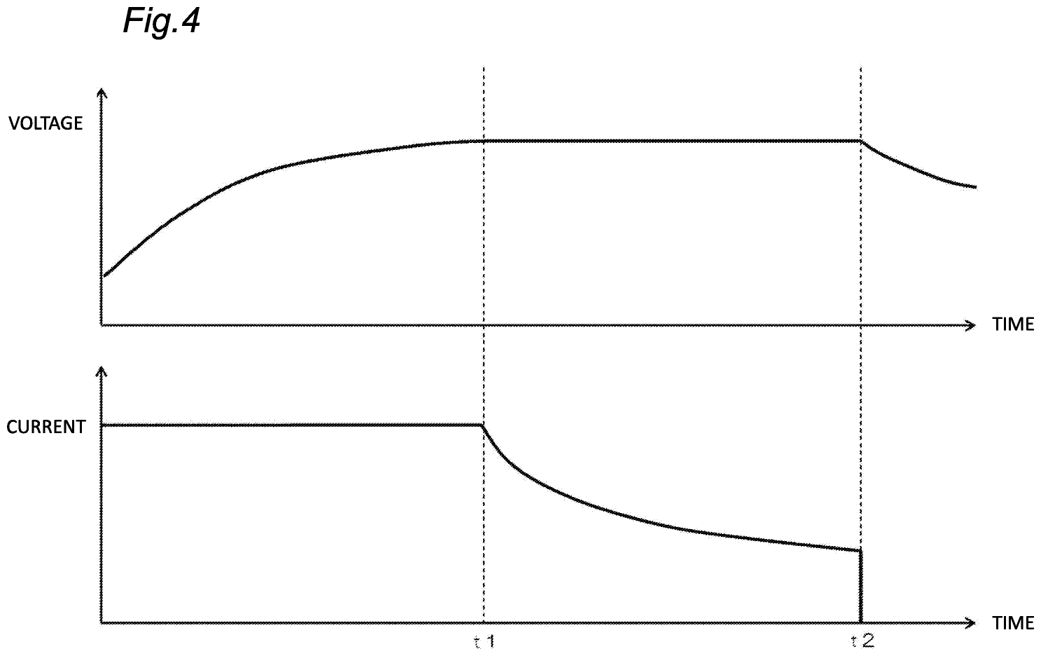

FIG. 4 is a graph illustrating a charging method in the case of charging a lithium ion secondary battery. The horizontal axes of the upper and lower graphs indicate time. The vertical axis of the upper graph shows the voltage, and the vertical axis of the lower graph shows the current.

In the lithium ion secondary battery described in the present embodiment, charging is performed by a method called a constant current constant voltage system. In this charging method, the battery cell block 310 is charged with a constant current in an initial stage of charging (a period until time t1). At that time, the voltage rises according to the amount of charge. In the following description of the present embodiment, this charging method is referred to as “CC charging”.

When a voltage rises to the vicinity of full charge, charging is performed with a constant voltage (a period of time t1-t2). In charging with a constant voltage, the charging current decreases as the voltage inside the battery cell block 310 increases. In the following description of the present embodiment, this charging method is referred to as “CV charging”. When charging is completed (time t2), charging is ended.

The first battery controller 329 and the controller 202 control the charging control based on the battery voltage value acquired from the battery cell block 310, the calculated current value, and the like.

As a factor that the lithium ion secondary battery generates smoking, ignition, etc., overcharging of the lithium ion secondary battery is considered, as shown in, for example, a prior art document. As another factor, for example, it is considered that metal foreign matter is mixed into the lithium ion secondary battery. The inclusion of such foreign matter is considered to occur when the foreign matter is mixed in the material used for the manufacture of the lithium ion secondary battery or when the foreign matter is mixed into the inside of the battery.

When the metal foreign matter is mixed in the inside of the lithium ion secondary battery, the foreign matter may cause a small short-circuit in the battery during use of the battery.

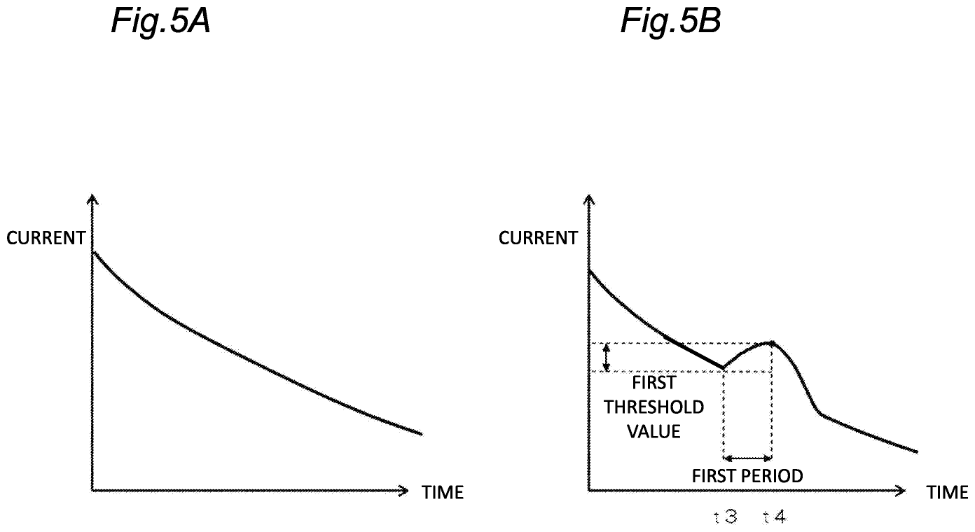

FIGS. 5A and 5B are graphs each showing a state of a charging current during the CV charging described with reference to FIG. 4. Each of horizontal axes in FIGS. 5A and 5B shows time, and each of vertical axes indicate a current value.

FIG. 5A is a graph showing a decrease in charging current in a normal lithium ion secondary battery. When the lithium ion secondary battery is normal, the charging current decreases almost monotonously. This is because the battery resistance increases as the lithium ion secondary battery approaches the full charge and the current value decreases.

FIG. 5B is a graph showing a decrease of charging current when a small short-circuit or the like locally occurs in the lithium ion secondary battery. As a cause of the electric short-circuit inside the battery, various causes such as a metal foreign matter contained in the battery and a relatively large burr in the electrode body can be considered. When the short-circuit occurs due to such a cause, the electric resistance of the lithium ion secondary battery is temporarily lowered, and the current value increases.

When the short-circuit phenomenon generated locally in the battery converges, the electric resistance of the entire lithium ion secondary battery returns to a state before the short-circuit. Thus, the reduction of the current value also returns to the original pace. When the short-circuit phenomenon does not converge, it is considered that heat generation continues, and finally, smoking and ignition occur.

The inventor of the present application continuously observes the state of a lithium ion secondary battery caused smoking and ignition. As a result, in the lithium ion secondary battery in which such a problem occurs, it has been found that there is a case in which the above phenomenon is observed before the problem occurs. Thus, the inventor of the present application performs detection of abnormality sign of a lithium ion secondary battery by capturing this event, and provides more safe handling.

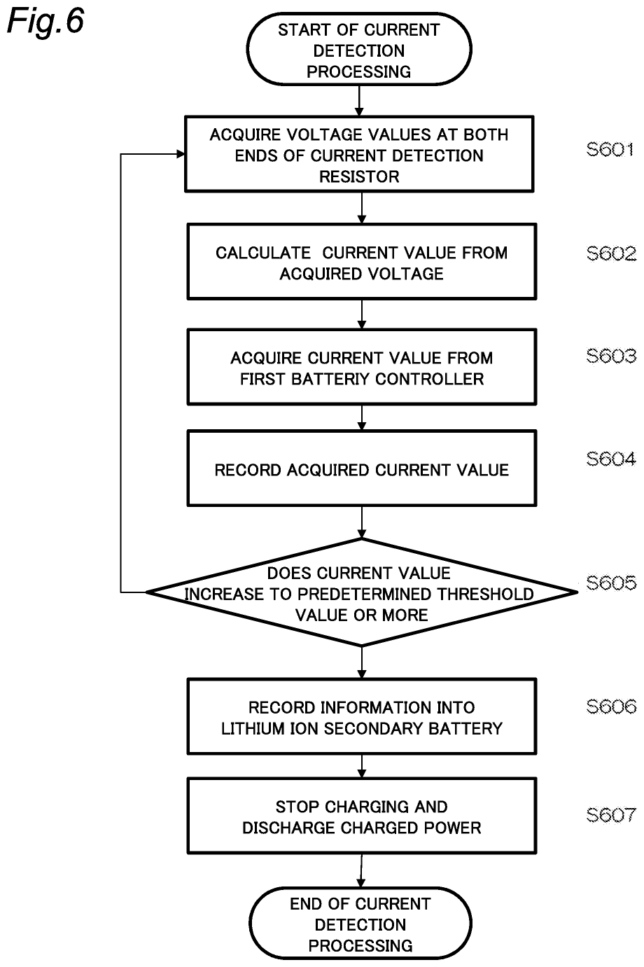

The detection method described above will be described with reference to a flowchart of FIG. 6. The processing of this flowchart is performed by the controller 202 and the first battery controller 329 described with reference to FIG. 2.

(Step s601) a first battery controller 329 acquires voltage values at both ends of the current detection resistor 324.

(Step s602) the first battery controller 329 calculates a voltage difference from the voltage values at both ends of the acquired current detection resistor 324, and calculates a theoretical current value from the voltage difference and the resistance value of the current detection resistor 324.

(Step s603) the first battery controller 329 transmits the calculated current value to the controller 202 of the main body 200 via the DATA terminal 323.

(Step s604) the controller 202 records the acquired current value into a storage unit such as a memory.

(Step s605) The controller 202 reads current value data recorded in a storage unit in a past predetermined period (first period). The controller 202 compares and determines whether or not the current value increases to a predetermined threshold value (first threshold value) or more in a predetermined period (first period) based on the read data.

When the current value continues to exceed the first threshold value for the predetermined period, the controller 202 moves the processing to step s606. When the current value does not increase or even if the current value is less than the first threshold value, the controller 202 returns to the processing of step s601.

(Step s606) the controller 202 requests the first battery controller 329 of the lithium ion secondary battery 300 to record control information based on the increase of the current to the reference level or more during the CV charging of the lithium ion secondary battery used. The first battery controller 329 that has received the request records the information into a non-volatile storage unit.

(Step s607) the controller 202 instructs the first battery controller 329 to stop charging. Furthermore, the controller 202 also instructs the first battery controller 329 to discharge the battery. This is for discharging the power charged in the lithium ion secondary battery 300 to stabilize the state of the lithium ion. Electric power discharged (supplied) from the lithium ion secondary battery 300 is inputted to a discharge electric circuit provided inside the load circuit 203 of the main body 200. Thus, the power stored in the battery cell block 310 is reduced.

As described above, by detecting a sign of increase of the charging current during the CV charging, the use of the lithium ion secondary battery suspected of causing the above phenomenon can be suppressed in an earlier stage before the phenomenon of smoking and ignition occurs in comparison with the conventional one. Thus, the lithium ion secondary battery can be more safely used.

In addition, the lithium ion secondary battery can be brought into a more stable state, because the charging to the lithium ion secondary battery is stopped and the already stored electric power is discharged. Thus, the lithium ion battery can be more safely used as compared with the conventional one.

In the above step s605, the controller 202 detects that the increase of current is detected by detecting that the current value increases to a “first threshold value” or more in a “predetermined period (first period)”. The setting of the “predetermined period (first period)” and the “first threshold value” may be performed as follows.

When setting the “predetermined period (first period)” and the “first threshold value”, it is necessary to consider the following points. That is, in the description with reference to FIGS. 5A and 5B, it has been described that current decreases during CV charging. However, in an actual product, even if the lithium ion secondary battery 300 is normal, the current may not substantially decrease due to noise and other factors. Therefore, when setting the “predetermined period (first period)” and the “first threshold value”, it is necessary to consider the influence of such noise or the like.

Various combinations may be considered as a combination of the “predetermined period (first period)” and the “first threshold value”. For example, when the target device is a device such as a personal computer, several combinations may be considered, for example, a current increase of 500 mA (first threshold value) or more is recognized, a current increase of 80 mA or more continues for two seconds, a current increase of 30 mA or more is recognized for three seconds, and a current increase of 10 mA or more is recognized for 5 seconds.

The controller 202 may detect (determine) the presence or absence of an increase in current by determining whether or not the condition is satisfied based on one condition relating to any one of a plurality of combinations as described above. Alternatively, the controller 202 may determine (detect) whether or not the current increase occurs when the condition relating to any one of the combinations is satisfied while determining whether or not the condition is satisfied in parallel with respect to each of the plurality of combinations. Alternatively, the controller 202 may determine (detect) that a current increase occurs when the conditions for two of the above combinations of the plurality of combinations are satisfied. Thus, the determination is made by combining a plurality of determination criteria, or the determination is made based on one determination criterion, thereby enabling detection with higher precision while suppressing the influence of disturbance such as noise.

The detection of the current increase is carried out in a state in which the charging power to the lithium ion secondary battery 300 satisfies a predetermined condition during the CV charging, so that the accuracy can be further improved. More specifically, in the case that the power consumption of the load circuit 203 increases, when the sum of the power supplied to the load circuit 203 and the charging power to the lithium ion secondary battery 300 exceeds the supply capability of the external power supply supplied from the power supply terminal 201, the charging power is narrowed. Thereafter, when the power consumption of the load circuit 203 becomes small, the throttle of the charging power is released. Thus, the charging current fluctuates according to the operating state of the load circuit. In consideration of this point, a condition for maintaining power supplied to the lithium ion secondary battery when the load circuit is operated in the various condition is calculated, and the detection is performed under a condition below a current value corresponding to the power. Thereby, the influence of the load circuit on the detection processing at the time of charging can be suppressed.

More preferably, the temperature change may be detected together with the detection of the current value by using the first temperature sensor 331, the second temperature sensor 332, and the like, and the temperature change may also be taken into consideration. The detection of the current value can be performed with higher precision by performing the detection at a constant temperature.

The information recorded in the first battery controller 329 described in step s606 is described as “control information based on the fact that the current increases to a reference level or more during the CV charging”, the information is, for example, information indicating that the event has occurred. However, the present disclosure is not limited to this. For example, the logical meaning of the information to be recorded is not particularly limited, as long as the information is information indicating that the subsequent use of the lithium ion secondary battery 300 is prohibited based on the fact, or information required to be recorded due to the fact.

Further, in step s607, the following processing may be added. More specifically, when the controller 202 determines in step s605 that the current value is increasing under a predetermined condition, the controller 202 notifies a CPU (not shown) or the like constituting the load circuit 203 to stop the use of the lithium ion secondary battery 300. The personal computer 100 displays a warning for strongly recommending the use stop of the lithium ion secondary battery 300 to an user on the display 102, or performs processing for automatically terminating processing after a fixed time, or displaying a time limit by which the lithium ion secondary battery 300 in use can be used on the display 102. Thus, the user can save and backup necessary data.

In addition, a case where processing from steps s601 to s603 of the lithium ion secondary battery 300 and processing from steps s604 to s605 of the main body 200 are performed synchronously is described with reference to FIG. 6. However, the present disclosure is not limited to this. For example, the processing of both of them can be independently processed. For example, in steps s601 to s603, it may be returned to step s601 after performing the processing of step s603. In steps s604 to s605, if the current value does not increases by a predetermined value or more in the determination of step s605, the processing returns to step s604. Both the independent processing can maintain the relation with data sent from the lithium ion secondary battery 300 to the main body 200.

### Second Embodiment

In the present embodiment, detection of an abnormal sign of a lithium ion secondary battery by observing temperature is described. Since the configuration of the hardware of this embodiment is the same as that described with reference to FIGS. 1 to 3 in the first embodiment, the description thereof is omitted.

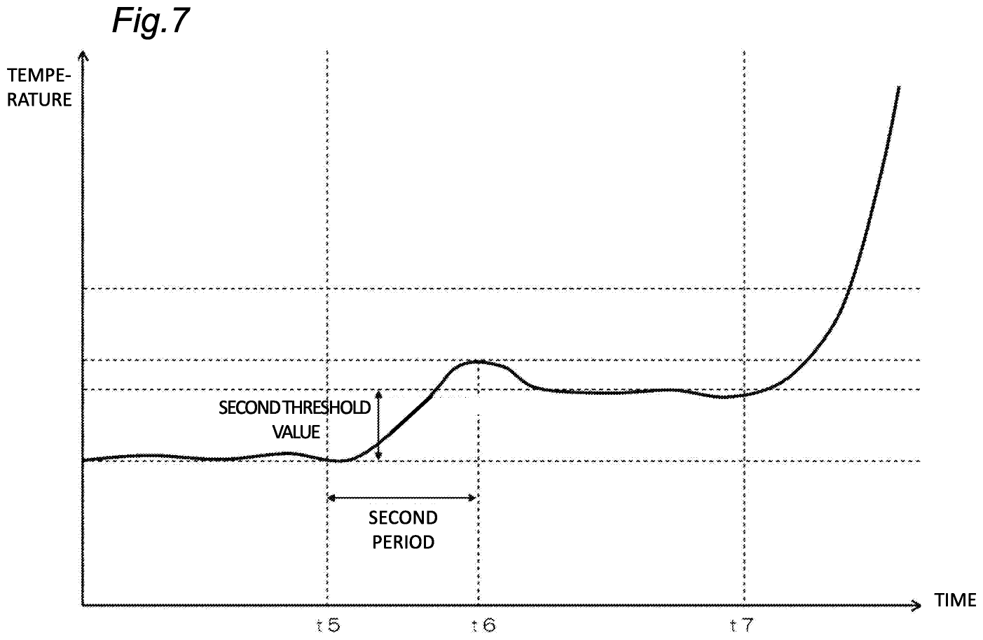

FIG. 7 is a graph showing an example of temperature change of the battery cell block 310 when the lithium ion secondary battery 300 is connected to the main body 200 and discharged or charged.

The horizontal axis of the graph of FIG. 7 indicates time, and the vertical axis indicates temperature. When a significant temperature rise as shown after the time t7 occurs, a short-circuit phenomenon occurs inside the battery cell block 310, which may lead to smoking and ignition without convergence.

In the present application, it is objected to detect a temperature rise as shown in a period (second period) from time t5 to time t6. The inventors of the present application have found that a temperature rise generated under a fixed condition in the period (second period) from time t5 to time t6 can be a sign of a drastic temperature rise occurring after time t7. Thus, in the present application, an event such a sign is detected.

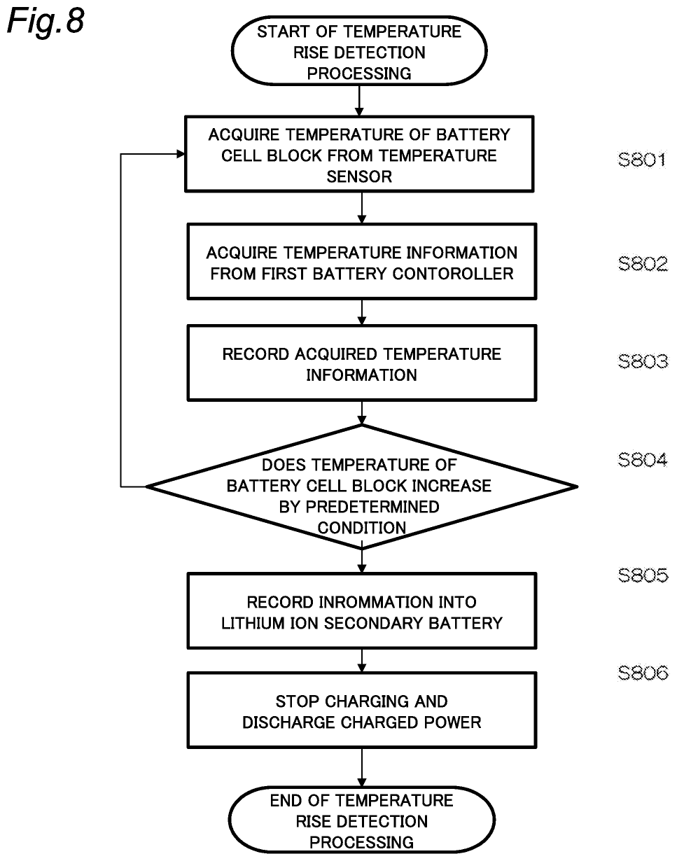

FIG. 8 is a flowchart showing the contents of temperature rise detection processing described in the present application. A sign detection using temperature is described below with reference to a flowchart of FIG. 8.

(Step s801) the first battery controller 329 acquires temperature information of the battery cell block 310 from the second temperature sensor 332.

(Step s802) the first battery controller 329 transmits temperature information of the battery cell block 310 to the controller 202 via the DATA terminal 323.

(Step s803) the controller 202 records the temperature information of the battery cell block 310 acquired from the first battery controller 329 into the storage unit.

(Step s804) the controller 202 confirms the temperature state of the past predetermined time (second period) recorded into the storage unit. Specifically, the controller 202 determines whether or not the temperature of the battery cell block 310 increases to a predetermined threshold value (second threshold value) or more within a predetermined time (second period). When the temperature of the battery cell block 310 rises to a predetermined threshold value (second threshold value) or more, the controller 202 proceeds to the processing of step s805. Even if the temperature of the battery cell block 310 is lowered, constant, or raised, the controller 202 returns to the processing of step s801 when the temperature is less than a predetermined threshold value (second threshold value).

(Step s805) the controller 202 requests the first battery controller 329 via the DATA terminal 323 to record control information based on the fact that a temperature rise equal to or higher than a predetermined range is detected in the used lithium ion secondary battery 300. When the first battery controller 329 receives the request, the first battery controller 329 records the information into an internal storage unit.

The above “control information based on detection of a temperature rise equal to or higher than a predetermined range in the used lithium ion secondary battery 300” is not limited to information indicating that the event has occurred. Other than this, the logical meaning of information to be recorded is not particularly limited, as long as the control information is information indicating that the subsequent use of the lithium ion secondary battery 300 is prohibited based on this event, or the information required to be recorded due to the fact.

(Step s806) the controller 202 instructs the first battery controller 329 to stop charging when the lithium ion secondary battery 300 is being charged. Furthermore, the controller 202 instructs the first battery controller 329 to discharge electric power stored in the battery cell block 310. Electric power discharged (supplied) from the lithium ion secondary battery is inputted to a discharge electric circuit provided inside the load circuit 203 of the main body 200. Thus, the power stored in the battery cell block 310 is reduced.

In the above description, only the temperature of the battery cell block 310 is acquired, and the determination is made based on the acquired temperature. However, the content of the present application is not limited to this. For example, the first battery controller 329 may acquire the ambient temperature (temperature of the surrounding environment) in which the lithium ion secondary battery 300 together with the temperature of the battery cell block 310, and calculate the temperature of the battery cell block 310 in consideration of the temperature information. Thus, the controller 202 can acquire the temperature of the battery cell block 310 with higher accuracy in which the influence of noise is suppressed.

The “predetermined condition” or the like used in step s804 is not limited to the above-described numerical content. These predetermined conditions are different depending on the number of cells to be used and the capacity of each cell. For example, for a lithium ion secondary battery for a laptop PC or the like, the condition of step s804 may be satisfied when a temperature rise of 3 degrees or more is detected in any of the battery cells in a period of 10 seconds also. For a lithium ion secondary battery used as a power source of an automobile, the condition of step s804 may be satisfied when at a temperature rise of 1.4° or more for 10 seconds is detected in any of the battery cells.

When the processing from steps s801 to s806 is performed during the discharge of the lithium ion secondary battery, that is, the load circuit 203 of the main body 200 operates using the power supplied from the lithium ion secondary battery, the controller 202 of the main body 200, (1) stops the operation using the power supply from the lithium ion secondary battery after a fixed time, (2) switches the load circuit 203 to the operation using these different power sources if another power source such as an external power source is provided, (3) causes a dedicated circuit for discharging to consume a power remaining in the lithium ion secondary battery. Thus, the user of the main body 200 can continue its use. In addition, the electric power remaining in the lithium ion secondary battery is consumed by the discharge-dedicated circuit, and the main body 200 can be changed to be in a stable state.

When the execution of the processing from steps s801 to s806 is not performed during charging or discharging of the lithium ion secondary battery, the power remaining in the lithium ion secondary battery is consumed by the discharge-dedicated circuit. Thus, the lithium ion secondary battery can be shifted to a more stable state.

A case where processing from steps s801 to s802 of the lithium ion secondary battery 300 and processing from steps s803 to s806 of the main body 200 are performed synchronously is described with reference to FIG. 8. However, the content described in the present application is not limited to this. For example, the processing of both of them can be independently processed. In this case, in the processing in steps s801 to s802, it may be returned to the step s801 after the processing of the step 802 is ended. In the processing in steps s803 to s806, it can be returned to the processing to step s803 when the temperature does not increase by a predetermined value or more in the processing of step s804. Both the independent processing can maintain the relation with data sent from the lithium ion secondary battery 300 to the main body 200.

Thus, by detecting the temperature change of the battery cell block 310, it is possible to detect a phenomenon leading to smoking or ignition of the lithium ion secondary battery 300, and to suppress the use of the lithium ion secondary battery having the possibility of abnormality. As a result, the lithium ion secondary battery can be more safely used.

### Third Embodiment

In the present embodiment, detection of an abnormal sign of a lithium ion secondary battery by observing a voltage in the present embodiment is describe. In the present embodiment, the configurations in FIGS. 1 to 3 are common to those of the first embodiment, and therefore, the description thereof is omitted.

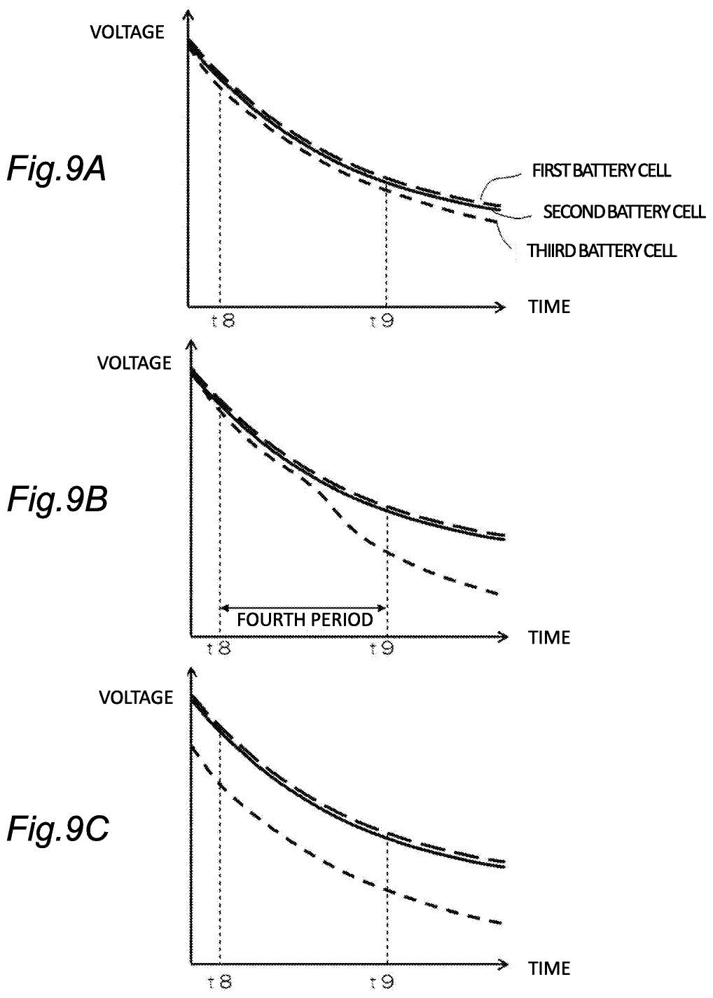

FIGS. 9A, 9B and 9C are graphs each showing changes in battery voltage at no load immediately after the battery cell block 310 is fully charged. The battery voltage of the battery cell block 310 of the lithium ion secondary battery 300 drops due to self-discharge according to passing of time, immediately after the full charge. The horizontal axes of FIGS. 9A, 9B, and 9C show time, and the vertical axes indicate the battery voltage of the cell constituting the battery cell block 310.

FIG. 9A is a graph showing a situation in which each voltage of cells constituting the battery cell block 310 drops in the substantially same manner. Voltages of the respective battery cells constituting the normal lithium ion secondary battery 300 drop in the substantially same manner.

FIG. 9B is a graph showing a case in which a voltage drop of one battery cell drops faster than a voltage drop of another battery cell among the battery cells constituting the battery cell block 310.

FIG. 9C is a graph showing a case in which a voltage of one of the battery cells constituting the battery cell block 310 changes in a state in which the voltage of one battery cell is always lower than that of another battery cell.

The inventor of the present application has found that events shown in FIGS. 9B and 9C is found in advance in a lithium ion secondary battery that reaches smoking and ignition. Therefore, the inventors of the present application have studied a method of detecting the lithium ion secondary battery capable of reaching smoking and ignition in advance by observing a voltage drop of the battery cell after the lithium ion secondary battery is fully charged.

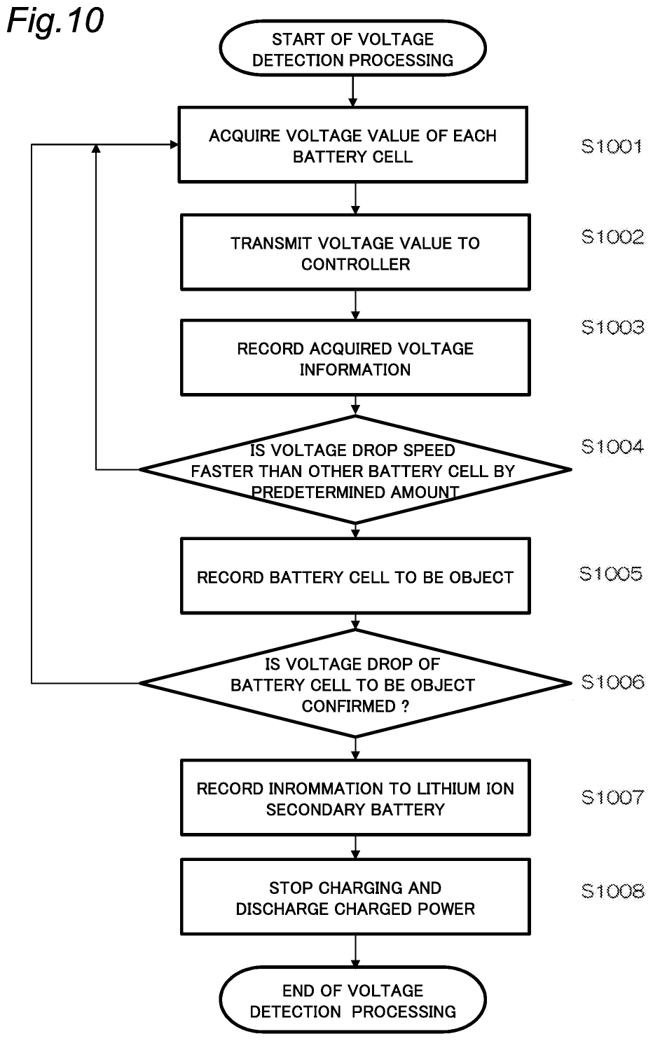

FIG. 10 is a flowchart of voltage detection processing of the battery cell described in the present application.

(Step s1001) the first battery controller 329 acquires a voltage value of each battery cell constituting the battery cell block 310.

(Step s1002) the first battery controller 329 transmits the acquired voltage value of each battery cell as voltage information to the controller 202 of the main body 200 via the DATA terminal 323.

(Step s1003) the controller 202 stores the voltage information acquired from the first battery controller 329 into the storage unit.

(Step s1004) the controller 202 reads voltage information of each cell stored in the storage unit in step s1003 for a predetermined period (third period), and calculates voltage drop speed of each battery cell. The controller 202 compares the calculated voltage drop speed of each battery cell.

More specifically, as described with reference to FIG. 9B, the controller 202 determines whether or not the voltage drop speed is faster than the speed of other battery cells by the predetermined amount, or the drop amount of the voltage drop of the battery cell in a predetermined period is equal to or more than a predetermined amount. The controller 202 can determine numerically based on a difference between a voltage value of a battery cell and a voltage value of a battery cell as a reference model serving as a reference or another battery cell in the predetermined period (third period).

When any of the battery cells constituting the battery cell block 310 corresponds to the above, the controller 202 moves the processing to a step s1005. If not, the controller 202 returns the processing to step s1001.

(Step s1005) the controller 202 determines that a voltage drop speed of a battery cell constituting the battery cell block 310 is equal to or more than the predetermined amount, or the voltage drop amount of the battery cell in the predetermined period is equal to or more than the predetermined value, the information is recorded into the storage unit.

(Step s1006) the controller 202 determines whether a voltage difference more than a predetermined amount exists constantly between battery cells constituting the battery cell block 310, as shown in FIG. 9C. The determination is performed on a battery cell in which abnormality of the voltage drop speed is detected in step s1004, in a charging cycle different from the charging cycle in which the detection processing of step s1004 is performed.

That is, the controller 202 determines whether a phenomenon as shown in FIG. 9C occurs, regarding battery cell having a high voltage drop speed as shown in FIG. 9B, in a charging cycle after the charging cycle in which the voltage drop is detected. Thus, the accuracy of the detection of the lithium ion secondary battery, which can be brought into an abnormal state, can be further enhanced.

When it is confirmed in step s1006 that a voltage is constantly reduced regarding a battery cell that is set to battery cell to be recorded in step s1005, the controller 202 moves the processing to a step s1007. On the other hand, when the constant voltage drop is not found, the controller 202 returns the processing to the step s1001.

(Step s1007) the controller 202 requests the first battery controller 329, via the DATA terminal 323, to record control information based on the fact that the voltage drop amount is abnormal in the battery cell block 310 of the lithium ion secondary battery 300 to be used. When the first battery controller 329 receives the request, the first battery controller 329 records the information into an internal storage unit.

Here, “the control information based on the occurrence of abnormality of the voltage drop amount in the battery cell block 310 of the lithium ion secondary battery 300” may be information indicating that the subsequent use of the lithium ion secondary battery 300 is prohibited by the occurrence of the event or information required to be recorded due to the event. The “control information based on the abnormality of the voltage drop amount in the battery cell block 310 of the lithium ion secondary battery 300” does not particularly limit the logical meaning of the information to be recorded.

(Step s1008) the controller 202 instructs the first battery controller 329 to discharge electric power stored in the battery cell block 310. Electric power discharged (supplied) from the lithium ion secondary battery 300 is inputted to a discharge electric circuit provided inside the load circuit 203 of the main body 200. Thus, the power stored in the battery cell block 310 is reduced.

Thus, by detecting the voltage change of the battery cells constituting the battery cell block, the smoking and ignition phenomenon of the lithium ion secondary battery 300 can be detected at an early stage compared with the conventional one, and the use of the lithium ion secondary battery having the possibility of abnormality can be suppressed. As a result, the lithium ion secondary battery can be more safely used.

As to the determination of whether or not the voltage drop amount is abnormal in step s1004, the case shown in FIGS. 9B and 9C is described as an example. However, the content described in the present application is not limited to this. For example, in the case possible to detect that only one cell is in a different electric state based on the comparison between the cells constituting the battery cell block 310, the determination may be done based on the detection.

The voltage detection processing described with reference to FIG. 10 can enhance the accuracy of detection by judging from a state (fully charged state) where charging of the lithium ion secondary battery 300 is filled, for example, from a state after the lapse of a predetermined time (3 minutes, 5 minutes, 10 minutes or the like). This is because; it is considered that, at the timing of immediately after the charging is stopped, the voltage drop is large due to a normal operation and it is difficult to improve detection accuracy, even if the detection is performed at the timing.

The detection processing of FIG. 10 is necessary to be performed in a state in which power is not exchanged between the main body 200 and the lithium ion secondary battery after fully charged, that is, in an unloaded state in which neither charging nor discharging of the lithium ion secondary battery is performed. When supply (discharge) of power is performed to the main body 200, especially the load circuit 203, the lithium ion secondary battery 300 is influenced by the load circuit 203, and then the battery voltage of the lithium ion secondary battery 300 move up and down, thereby making it difficult to detect the battery voltage in the detection processing described above. The battery voltage of each cell of the battery cell block 310 is affected by the main body 200 such as the load circuit 203, and the accuracy of detection processing is reduced. In addition, even when charging to the lithium ion secondary battery, the charging power is varied due to the influence of the magnitude of the load of the main body side, and the accuracy of the detection processing is reduced similarly. Therefore, in order to maintain and improve accuracy, it is required that during the detection period, neither charging nor discharging of the lithium ion secondary battery 300 is performed in a state equal to an electrically non-connected state.

It should be noted that although the above description is described regarding “after full charging (after charging)”, it is not necessary to be in full charging. For example, the detection processing of FIG. 10 may be executed in a state in which the battery cell block 310 has a battery voltage equal to or more than a predetermined battery voltage, such as 80% or more for a prescribed battery voltage. Other than this, every time the voltage of the lithium ion secondary battery is 20%, 40%, 60%, 80%, or the like of the prescribed battery voltage, the charging may be stopped once and the processing shown in FIG. 10 may be performed by the controller 202 or the first battery controller 329.

In the example of FIGS. 9 and 10, the battery cell block 310 is formed of a plurality of cells. However, the content described in the present application is not limited to this. When the battery cell block 310 is composed of only one battery cell, a reference model or the like may be provided in advance as a caparison object, and the reference model may be compared with the measured voltage value. Thus, the same detection can be performed even in the case of a single cell.

When the battery cell block 310 is composed of only one battery cell, steps s1005 and s1006 of the processing described with reference to FIG. 10 may be omitted. This is because, in the case of a single battery cell, this can be detected with high accuracy.

Further, in FIG. 10, a case where processing from steps s1001 to s1002 of the lithium ion secondary battery 300 and processing from steps s1003 to s1009 of the main body 200 are performed synchronously. However, the present disclosure is not limited to this. For example, the processing of both of them may be performed independently. For example, in steps s1001 to s1002, it may be returned to step s1001 after the processing of step s1002 is ended. In steps s1003 to s1009, it may be returned to step s1003 after the processing of step s1005, s1006, and s1007 is ended. Both the independent processing can maintain the relation with data sent from the lithium ion secondary battery 300 to the main body 200.

Further, in step s1009, the following processing may be added. Specifically, the controller 202 notifies a CPU (not shown) or the like constituting the load circuit 203 to request stopping the use of the lithium ion secondary battery 300. The personal computer 100 performs a processing for displaying a warning for strongly recommending to a user to stop the use of the lithium ion secondary battery 300 on the display 102, or performs a processing for automatically finishing the processing after a fixed time, or performs a processing for displaying an end time to which the lithium ion secondary battery 300 during use can be used on the display 102. Thus, the user can save and backup necessary data.

As described above, first to third embodiments are described as an example of the technique disclosed in the present application. However, the technique of the present disclosure is not limited to this. In particular, the description is not limited to the description of the description using a numerical value.

The technical contents described in the first to third embodiments can be applied to an embodiment in which a change, replacement, addition, omission, or the like is performed as appropriate. Further, the components described in the first to third embodiments may be combined to form a new embodiment.

For example, a sign may be detected by checking all the conditions of the charging current, the temperature, and the voltage described in the first to third embodiments. In this case, when any one of three sign conditions is satisfied, or two of the three sign conditions are satisfied, or all of the three sign conditions are satisfied, the stop of charging and the discharge of power charged in the battery cell block 310 may be performed. Any of the three sign conditions may be selected in accordance with a safety level or the like required for an electronic apparatus using the lithium ion secondary battery 300.

In first to third embodiments, the case where the main body 200 and the lithium ion secondary battery 300 are independent is described as an example. However, the present disclosure is not limited to this. For example, the main body 200 and the lithium ion secondary battery 300 may be fixedly assembled in one device. When the present disclosure is applied to a device for controlling charging and discharging to a lithium ion secondary battery, the present disclosure may be configured as an independent device from another device or as a single device.

In first to third embodiments, a control device and a control method according to the present disclosure are described with reference to flowcharts of FIGS. 6, 8, and 10. However, the control device and the control method in the first to third embodiments are examples of the control device and the control method according to the present disclosure, and are not limited to this.

In the description of first to third embodiments, when a sign is detected, it is described that charging and the discharge of the stored power is stopped. However, the present disclosure is not limited to this. For example, in the personal computer 100, a warning screen may be displayed for a user for a certain period of time, and then forcibly shifted to the hibernation mode, or a shutdown operation or the like may be performed. The operation when the sign is detected may be appropriately performed according to a use purpose of the electronic apparatus connected to the lithium ion secondary battery and the reliability required for the electronic apparatus.

### INDUSTRIAL APPLICABILITY

The technique described in the present application is industrially used in electronic apparatus or the like using lithium ion secondary battery can be made.

What is claimed is:

1. A control device for controlling a lithium ion secondary battery, comprising:
a controller that detects a charging current when performing constant voltage charging to the lithium ion secondary battery, wherein
the controller stops charging of the lithium ion secondary battery and records control information based on the increase of the charging current into a storage unit included in the lithium ion secondary battery, when the charging current increases by a predetermined amount within a predetermined time period.

2. The control device of the lithium ion secondary battery according to claim 1, wherein there is a plurality of combinations as the combination of the predetermined time and the predetermined amount, and the longer the time period of the predetermined time is, the smaller the predetermined amount is.

3. The control device of the lithium ion secondary battery according to claim 1, wherein the controller further causes the lithium ion secondary battery to discharge the electric power stored therein when the charging current increases by a predetermined amount within a predetermined time.

4. A control device for controlling a lithium ion secondary battery, comprising:
a controller that calculates a temperature of the battery cell constituting the lithium ion secondary battery, wherein
the controller records control information based on the temperature calculation into a storage unit included in the lithium ion secondary battery, when the temperature rises by a predetermined amount or more within a predetermined period of time.

5. The control device of the lithium ion secondary battery according to claim 4, wherein the controller calculates the temperature of the battery cell so that influence by the ambient temperature of the lithium ion secondary battery is suppressed.

6. A control device for controlling a lithium ion secondary battery, comprising:
a controller that detects a voltage of the battery cell constituting the lithium ion secondary battery, after the lithium ion secondary battery is charged to a predetermined voltage or more, wherein
the controller records control information based on the voltage detection to a storage unit included in the lithium ion secondary battery, when the voltage drop of the voltage is different from the voltage drop of the battery cell of the reference model by a predetermined amount or more.

7. The control device of the lithium ion secondary battery according to claim 6, wherein
a battery cell constituting the lithium ion secondary battery is composed of a plurality of battery cells,
the controller detects each voltage of the plurality of battery cells, and when the voltage drop of any one of the battery cells is different from the voltage drop of the battery cell of the reference model by a predetermined amount or more, the controller records control information based on the detection of the voltage drop in the storage unit included in the lithium ion secondary battery.

8. The control device of the lithium ion secondary battery according to claim 7, wherein the battery cell of the reference model is other battery cell of the plurality of battery cells.

9. A control Method for controlling lithium ion secondary battery, comprising:
detecting a charging current when the lithium ion secondary battery is charged at a constant voltage, and
stopping charging of the lithium ion secondary battery and recording control information based on the increase of the charging current into a storage unit included in the lithium ion secondary battery, when the charging current increases by a predetermined amount within a predetermined time period.

10. A control method for controlling a lithium ion secondary battery, comprising:
calculating a temperature of the battery cell constituting the lithium ion secondary battery, and
recording control information based on the temperature calculation into a storage unit included in the lithium ion secondary battery, when the temperature rises by a predetermined amount or more within a predetermined period of time.

11. A control method for controlling a lithium ion secondary battery, comprising:
detecting a voltage of a battery cell constituting the lithium ion secondary battery, after the lithium ion secondary battery is charged to a predetermined voltage or more, and
recording control information based on the voltage detection to a storage unit included in the lithium ion secondary battery, when the voltage drop of the voltage is different from the voltage drop of the battery cell of the reference model by a predetermined amount or more.
